(19) United States
(12) Patent Application Publication
(10) Pub. No.: US 2008/0287330 A1
(43) Pub. Date: Nov. 20, 2008

(54) Method of Removing Laundry Ash

(75) Inventor: Fabio Corradini, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/571,678

(22) PCT Filed: Jul. 8, 2005
(86) PCT No.: PCT/GB2005/002663

§ 371 Date: Jan. 10, 2007

(30) Foreign Application Priority Data
Jul. 8, 2004 (GB) 0415316.9

(51) Int. Cl. C11D 3/20

(52) U.S. Cl. 510/109

(57) ABSTRACT

This invention relates to a method of removing and preventing the deposition of hard water scale in a clothes washing machine. In particular the method relates to the removal of and prevention of scale build up after the main wash of a clothes washing machine, by use of an acidic composition. The invention also relates to water-softening compositions for such methods.

This invention relates to a method of removing and preventing the deposition of hard water scale in a clothes washing machine. In particular the method relates to the removal of and prevention of scale build-up after the main wash of a clothes washing machine. The invention also relates to water-softening compositions for such methods.

It is well known that certain metal compounds, notably calcium compounds, when present in water, have a significant effect on the properties of the water. For example, “hard” water containing a significant loading of soluble calcium and magnesium compounds may require a large amount of soap or detergent in order to form a lather. Scale deposits can readily form from such water, for example on heating or pH change or evaporation. These can be incrustations, which are left on a surface that has come into contact with the hard water. Particular issues arise in ware washing machines, such as dish and clothes washing machines. In particular scale incrustations may be left on the surfaces of the machines as well as the items washed therein. In particular issues arise with incrustation of heating elements, which reduced their life span and efficiency. A further issue arises in that scale incrustation can be found on the surface of clothes washed in the clothes washing machines which are perceptible to the wearer as feeling harsh to the touch.

There have been many proposals for removal of metal ions from aqueous solutions. In the industrial context proposals have included filter beds and polymeric filters for capturing heavy metal ions from an aqueous solution flowing within a passageway. Examples are given in EP992238A and GB20869564A. In the domestic context chelating compositions can be added to an aqueous washing solution and these can capture metal ions, such as calcium ions. Examples of chelating compositions are given in EP892040A.

Typically in ware washing machines cleaning compositions are provided which are “built” which provide a water softening effect and an increase to the efficiency of the detergent used therein. However, such compositions are not effective for softening the water in the rinse cycle of ware washing machines since such compositions are pumped out of the machine along with the dirty water prior to the rinse cycle. Therefore, scale deposits may build up on the hard surfaces of the washing machine such as the heating element, as well as the fabric of the items being worked.

We have previously found (WO 3080918) that by providing a water-softening agent to the rinse cycle of a ware-washing machine significant benefits can be found, such as reduction in the amount of incrustation and/or water marks caused during the rinse cycle. In addition we have found benefits on the softness of the fabrics after the wash, a reduction in the degree of shrinkage of the fabrics and a reduction in the amount of wrinkles found on the fabrics after the wash.

Typically, such compositions contain sufficient acidity that they neutralise the alkaline residues from the main wash cycle only. In addition, the Ca²⁺chelating, ability of the composition typically is to build the Ca²⁺ found in the rinse water.

We have found that by increasing the acidity of the rinse added composition there are surprisingly improved benefits. In particular, existing scale in the machine is removed.

Therefore, we present as a feature of the invention a method of removing and preventing the deposit of limescale in a clothes washing machine, by providing a composition having a pH of at least 0.5, 0.9, 1.0, 1.3, 1.5, 1.7, 1.9, 2.1, 2.3, 2.5, 2.7, 2.9 or 3.0 and, at most, of 4.0, 3.5, 3.3, 3.2 or 3.1. Preferably the delivery is into the rinse cycle.

Preferably the method is carried out while the machine is being used for washing clothes. The invention may alternatively be defined as a method of washing clothes, in which the defined method is applied to remove or prevent the deposit of limescale.

Preferably the composition is substantially free from any fabric softening actives, surfactant, and/or bleach. By substantially herein free we mean <15% wt, <12% wt, <10% wt, <8% wt, <6% wt, <4% wt, <2% wt, <1% wt, <0.5% wt, <0.1% wt, <0.01% wt of each and any combination or all of the ingredients listed above.

A number of different techniques can be envisaged for the delivery of a water-softening agent to a clothes washing machine during the rinse cycle.

A simple technique can be used in a clothes washing machine where the composition is added into the dispensing drawer, usually reserved for the fabric conditioner. Alternatively a “rinse hold” cycle is selected on the clothes washing machine, found on most machines and used so that the user may add bleach to the rinse cycle, and the composition is added directly to the water of the rinse cycle, optionally in addition to a bleaching composition or fabric softening composition.

A more sophisticated technique would be to provide sustained release of the water-softening active through the wash and rinse cycle in a single product. Delayed release of the water-softening agent could be used such that the agent is released during the rinse cycle only, or substantially most of the composition (greater than 50%) is released into the rinse cycle.

Delayed or sustained release can be achieved in several ways.

In a preferred method a water-softening active(s) is/are provided during the main wash cycle, and a composition or method of the invention is employed during the rinse cycle.

Therefore, we present as a feature of the invention a method comprising two separate additions of water-softening composition. The second is of the composition defined above, and is added into the rinse cycle. The first addition may be of that same composition, or of a different water-softening composition.

Instructions may be provided the user of the product to add water-softening composition to the wash cycle of a clothes-washing machine and to add the water-softening composition to the rinse cycle of the clothes washing machine.

Preferably, the first composition may comprise a heavy or light duty laundry detergent and/or comprise a water softening composition, substantially free of any fabric-softening actives, surfactant, and/or bleach.

### Acidity

Preferably acidity is provided by an organic acid, preferably a polycarboxylic acid, or by phosphoric acid or boric acid or sulphamic acid. Preferred carboxylic acids include citric, acetic, formic, glycolic and oxalic acid. Preferably the acid is citric acid.

Preferably the acid is not buffered by a deliberate addition of a buffer compound.

### Water Softening Agent

Ideally, a water softening agent is also present (in addition to the acidifying agent which may, depending on its selection, also be a water softening agent). Preferred amounts of (additional) water-softening agent are from 5 to 80% wt, preferably 1 to 30% wt preferably 2 to 20% wt, most preferably 5 to 15% wt.

There are three main types of method of action for water-softening agents, described below.

1) Ion exchange agents—such agents include alkali metal (preferably sodium) aluminosilicates either crystalline, amorphous or a mixture of the two. Such aluminosilicates generally have a calcium ion exchange capacity of at least 50 mg CaO per gram of aluminosilicate, comply with a general formula:

0.8-1.5Na₂O.Al₂O₃.0.8-6SiO₂

and incorporate some water. Preferred sodium aluminosilicates within the above formula contain 1.5-3.0 SiO₂ units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, and mixtures thereof. Also of interest is zeolite P described in EP 384070 (Unilever).

Another class of compounds are the layered sodium silicate builders, such as are disclosed in U.S. Pat. No. 4,464,839 and U.S. Pat. No. 4,820,439 and also referred to in EP-A-551375.

These materials are defined in U.S. Pat. No. 4,820,439 as being crystalline layered, sodium silicate of the general formula

NaMSiₓO₂ₓ₊₁.YH₂O

wherein

M denotes sodium or hydrogen,

x is from 1.9 to 4 and y is from 0 to 20.

Quoted literature references describing the preparation of such materials include Glastechn. Ber. 37, 194-200 (1964), Zeitschrift für Kristallogr. 129, 396-404 (1969), Bull. Soc. Franc. Min. Crist., 95, 371-382 (1972) and Amer. Mineral, 62, 763-771 (1977). These materials also function to remove calcium and magnesium ions from water, also covered are salts of zinc which have also been shown to be effective water softening agents.

2) Ion capture agents—agents which prevent metal ions from forming insoluble salts or reacting with surfactants, such as polyphosphate, monomeric polycarboxylates, such as citric acid or salts thereof, polycarboxylate polymers, such as polyacrylates, acrylic/maleic copolymers, and acrylic phosphonates, EDTA, algins, alginates.

3) Anti-nucleating agents—agents that prevent seed crystal growth, such as polycarboxylate polymers, such as polyacrylates, acrylic/maleic copolymers, and acrylic phosphonates, and sulfonates. Such polymers may also act as ion capture agents as well.

Preferred organic water-soluble water softening agents which may be present include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates, hydroxyethyliminodiacetates, phosphonates, iminodisuccinates, polyaspartic acids, BHT, phosphonate stabilisers such as, diethylenetriaminepenta (methylene phosphonic acid and its corresponding pentasodium salt) available under the trade names Dequest 2060 and Dequest 2066 Monsanto Chemical Co), DTPMP and DTPMA (Dequest 2010) and HEDP.

Preferably the water-soluble water softening agent is a neutralised or partially neutralised carboxylic acid, such as citric acid, succinic acid or maleic acid, and/or a neutralised or partially neutralised polycarboxylic acid, such as a polyacrylate of Mw: 4000-8000 (such as Acusol 445N (Rohm & Haas) CAS REG Nr. 66019-18-9 or Sokalan from BASF).

Thus a preferred composition used in the present invention contains an acidifying agent which is also a water softening agent.

In this invention the method is used in successive washes, for example at least 10 washes; it is preferably not something which is done as a special cleaning measure.

In accordance with a further aspect of the present invention there is provided a composition as defined herein in relation to the method of the present invention.

The invention will now be described, by way of embodiment, with reference to the following examples.

### EXAMPLES 1-4

| Function | Ingredient | Example 1 | Example 1 | Example 3 | Example 4 |
|---|---|---|---|---|---|
| Acidifying | Citric acid | 20.00 | 35.00 | 24.00 | 45.00 |
| agent | | | | | |
| Water | Acusol 445 | 11.20 | 7.40 | 8.70 | 9.50 |
| softening | | | | | |
| polymer | | | | | |
| Thickener | Xanthan | 0.10 | 0.10 | 0.15 | 0.15 |
| | gum | | | | |
| Stabiliser | IDS | 0.50 | — | 0.50 | 0.50 |
| (chelating) | (imminodi- | | | | |
| | succinate) | | | | |
| Pre- | Acticide | 0.15 | 0.10 | 0.10 | 0.10 |
| servative | F (N) | | | | |
| Minors - | Proprietary | 0.10 | 0.10 | 0.10 | 0.10 |
| dye, | | | | | |
| perfume | | | | | |
| Solvent | Water | Balance | Balance | Balance | Balance |

The compositions are added into the washing machine both in the main wash cycle (40 ml) and in the rinse cycle (40 ml); or just in the rinse cycle (60 ml). Given that the compositions are intended to be used every wash for “keep clean action”, not occasionally for “get clean action”, the test regime was 100 washes of clothes at 60° C. (normal programme). The compositions give excellent performance in providing good water softness and avoiding laundry ask build-up.

### EXAMPLE 5

The composition identified below, when added into the rinse water of a fabric washing machine, or into the main wash water and the rinse water, is found to have excellent laundry ash combating properties.

50% wt citric acid
Others (water, preservative, thickener, perfume, dye) pH=1.8

1. A method of removing and preventing the deposit of limescale in a clothes washing machine during the use of the machine in washing clothes, the method including the step of adding a composition having a pH of at least 0.5 and at most 4.0 to the water in the rinse cycle of the clothes washing machine.

2. A method as claimed in claim 1, wherein the composition additionally comprises a water-softening agent selected from an ion exchange agent, and ion capture agent or an anti-nucleating agent, or a mixture of any thereof.

3. A method as claimed in claim 1, wherein the composition is in the form of a thickened liquid.

4. A method as claimed in claim 1, wherein the composition is added into the fabric softening dispensing drawer of a clothes washing machine.

5. A method as claimed in claim 1, wherein the same or a different water softening compound is also added to the water in the main wash.

6. A method according to claim 1 wherein the pH of the composition is in the range 1.5-3.2.

7. A method according to claim 1, wherein the composition comprises a polycarboxylic acid.

8. A method as claimed in claim 7, wherein the composition comprises citric acid.

9. A method according to claim 1 wherein the composition is substantially free from a fabric softening active, surfactant and/or a bleach.

10. A method as claimed in claim 2, wherein the composition is in the form of a thickened liquid.

11. A method as claimed in claim 2, wherein the composition is added into the fabric softening dispensing drawer of a clothes washing machine.

12. A method as claimed in claim 2, wherein the same or a different water softening compound is also added to the water in the main wash.

13. A method according to claim 2 wherein the pH of the composition is in the range 1.5-3.2.

14. A method according to claim 2 wherein the composition comprises a polycarboxylic acid.

15. A method as claimed in claim 14, wherein the composition comprises citric acid.

16. A method according to claim 2 wherein the composition is substantially free from a fabric softening active, surfactant and/or a bleach.
